(19) United States
(12) Patent Application Publication
(10) Pub. No.: US 2006/0206697 A1
(43) Pub. Date: Sep. 14, 2006

(54) System and method for trellis-based decoding

(75) Inventors: Eran Pisek, Plano, TX (US); Thomas Henige, Dallas, TX (US)

Correspondence Address: DOCKET CLERK, P.O. DRAWER 800889, DALLAS, TX, 75380, US

(73) Assignee: Samsung Electronics Co., Ltd., Suwon-city (KR)

(21) Appl. No.: 11/317,268

(22) Filed: Dec. 23, 2005

Related U.S. Application Data
(60) Provisional application No. 60/653,968, filed on Feb. 17, 2005.
(60) Provisional application No. 60/682,338, filed on May 18, 2005.
(60) Provisional application No. 60/682,339, filed on May 18, 2005.
(60) Provisional application No. 60/729,998, filed on Oct. 25, 2005.

(51) Int. Cl. G06F 7/00

(52) U.S. Cl. 712/300

(57) ABSTRACT

A decoder comprising a demodulator operable to receive a plurality of encoded data bits and generate a demodulated output, a channel decoder coupled to the demodulator operable to receive the demodulated output and generate decoded data bits, an encoder coupled to the channel decoder operable to receive the decoded data bits and re-encode the decoded data bits and generate re-encoded data bits, a comparator coupled to the demodulator and the encoder and operable to compare the demodulated output and the re-encoded data bits and generate an error rate, and wherein the error rate from the comparator is used to modify an operating parameter of the channel decoder.

### RELATED APPLICATIONS

This application claims the benefit of U.S. Provisional Patent No. 60/653,968 filed on Feb. 17, 2005 and entitled “Context-Based Operation Reconfigurable Instruction Set Processor,” Provisional Patent Application No. 60/682,338 filed on May 18, 2005 and entitled “Turbo Code Decoder Architecture For Software-Defined Radio,” Provisional Patent Application No. 60/682,339 filed on May 18, 2005 and entitled “Viterbi Decoder Architecture For Software-Defined Radio,” and Provisional Patent Application No. 60/729,998 filed on Oct. 25, 2005 and entitled “System and Method for Trellis-Based Decoding, ” all of which are incorporated herein by reference.

### BACKGROUND

Channel decoding algorithms are currently used in a wide range of wireline and wireless networks such as GSM (Global System for Mobile communication), EDGE (Enhanced Data for Global Evolution), 802.xx, W-CDMA (wide-band Code-Division Multiple Access), HSDPA (High Speed Downlink Packet Access), CDMA2000, and DVB (Digital Video Broadcasting). The channel decoding algorithm has two processing modes: feed-forward processing and traceback processing. Feed-forward processing is also known as Alpha Calculation in turbo decoding, and traceback processing is also known as Beta/Lambda Calculation in turbo decoding. These algorithms are also commonly called trellis-based decoding algorithms because the relationship between the input and output data sequences forms a trellis-like structure.

In certain applications such as mobile communication devices where the quest for reductions in energy consumption and size is ongoing and never satisfied, any reduction in computational requirements of trellis-based decoding is desirable.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified diagram illustrating the naming convention of variables used in the trellis-based decoding algorithm;

FIG. 2 is a simplified block diagram of an embodiment of a decoder; and

FIG. 3 is a simplified block diagram of an embodiment of a reconfigurable processing system having a plurality of context-based reconfigurable processors.

### DETAILED DESCRIPTION

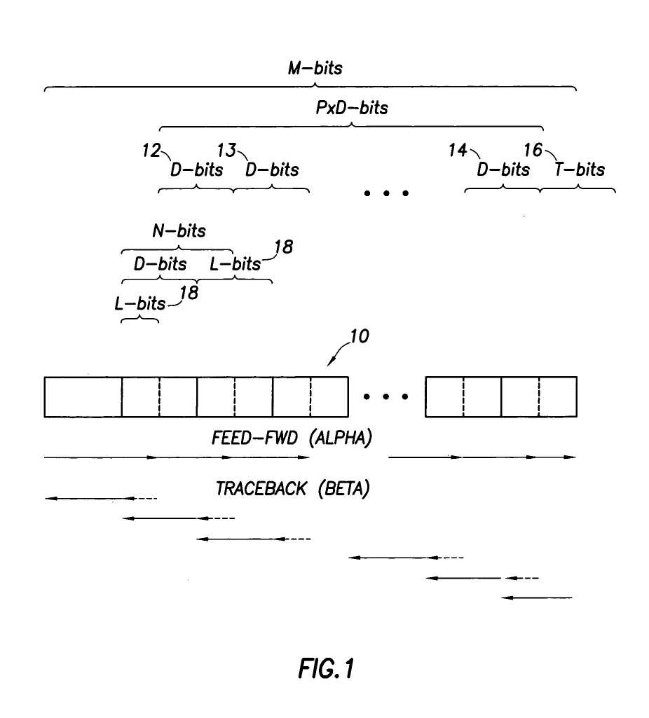

The trellis-based decoding algorithm naming convention is shown in FIG. 1. The processing time for one of the processing modes (usually the feed-forward processing mode) is generally dependent on a variable M, which is the number of bits in the bit-stream or block 10. The processing time of the other processing mode (usually the traceback processing mode) is generally dependent on M+P*L, where P is the number of D blocks and L is the traceback learning period. In the case of P=0, which means that the traceback mode starts only after the feed-forward mode ends for all M bits, the traceback processing time is equal to M, and the amount of path metric/trellis memory required is multiplied by M as well. For small M blocks, where M is on the order of (5*K), where K is the constraint length, the P=0 solution may satisfy both the memory and power requirements of mobile communication devices. However in currently deployed wireless standards, the size of M is much greater than (5*K), and for many systems, in particular wireless communication devices, the reduced power and memory size requirements make this computation unmanageable.

The M-bit blocks 10 may each be divided into sub-blocks called “windows” of D-bits 12-14, where M=P*D+T. P is the number of full D-bit windows 12-14 in M and T 16 is the tail bits at the end of the block (T<D). The process of dividing the M blocks 10 into a chain of D sub-blocks 12-14 does not affect the feed-forward mode in the trellis decoding algorithm. However, this process may significantly affect the traceback session, since traceback time is M+P*L, where L is the traceback learning period 18. Hence, the more D sub-blocks are in the M block, the greater the traceback processing time. For certain applications, for example, for WCDMA, where K=9 for Viterbi, D=64, M=5114, L=45 and traceback overhead time is about 3600 cycles.

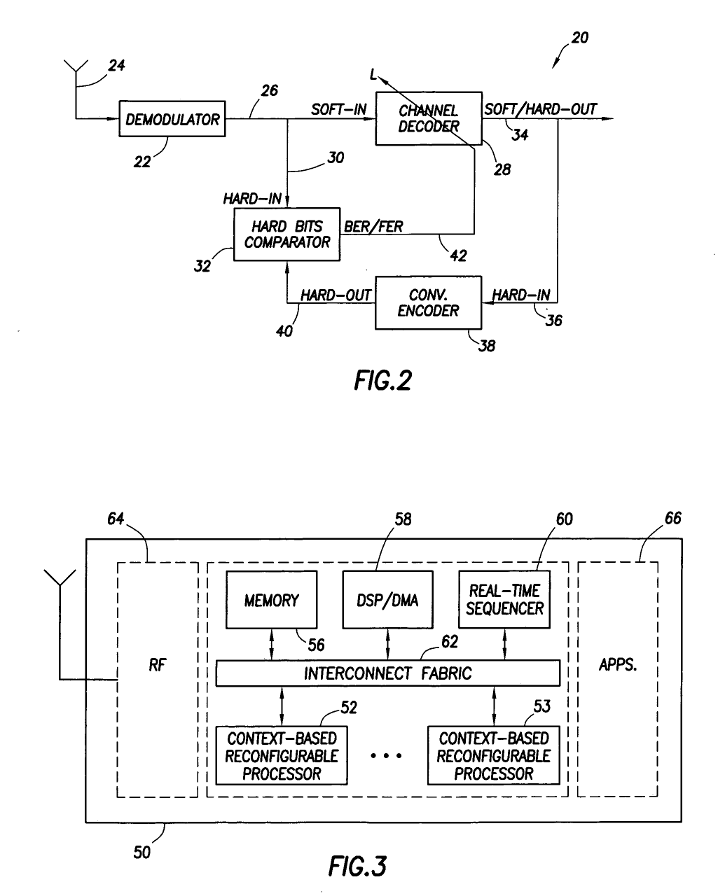

It may be seen that it is desirable to increase the size of D for a given M, but also reduce the traceback processing time or the traceback overhead time of (P*L). Increasing the size of D or window size may result in adverse implications on the memory requirement and increase power consumption. Focusing on reducing L, a trellis-based decoder is devised and shown in FIG. 2.

FIG. 2 is a simplified block diagram of a decoder or method 20 that enables a reduction in overhead in processing time and power consumption. The decoder and method 20 are operable to detect low/high signal-to-noise ratio (SNR) inputs and further operable to manually or automatically adjust the length of L based on the bit-error-rate (BER) or frame-error-rate (FER). The circuit comprises a demodulator 22 operable to receive data input from an antenna 24. The demodulator 22 is operable to provide a hard value as a soft-input 26 into a channel decoder 28 and a hard-input 30 to a comparator 32. A soft value is a value that has associated therewith a probability. The channel decoder produces a hard output 34, which is provided as a hard-input 36 to a convolution encoder 38 which re-encode the decoded bits. The re-encoded bits 40 from the convolution encoder 38 is also provided to the comparator 32. The comparator 32 compares the hard-input 30 received from the demodulator 22 and the re-encoded bits 40 from the convolution encoder 38 and generates a bit-error-rate or frame-error-rate output 42, which is used to adjust L, the traceback learning period of the channel decoder 28.

For low bit-error-rate, the L can be reduced to about (K-1), for example. For example, for WCDMA, where K=9 for Viterbi, D=64, and M=5114, (P*L)=640 for L=8. This reduces the overhead by 2960 cycles. The overhead portion is only (640/5114), which is 0.125 instead of (3600/5114), which is 0.7. This translates to significant power savings in case of high signal-to-noise-ratio and low bit-error-rate. For high bit-error-rate, L is about 5*K. Therefore, L is between the values of (5*K) and (K-1) or (5*K)>L>(K-1).

The system components—the demodulator, channel decoder, convolution encoder, and comparator may be implemented with components as known in the art or incorporate technology to be developed in the future. The primary functionality of these components in view of the system shown in FIG. 2 are well-known and thus details of these components are not described herein for the sake of clarity and brevity.

The method provides the re-encoding of decoded bits 36 and comparing the re-encoded bits 40 with the received encoded bits 26 to generate a bit-error-rate or frame-error-rate 42. The bit-error-rate or frame-error-rate 42 is then used to adjust or reduce the learning period length, L, of the channel encoding process. Therefore, the channel decoder 28 produces an output that takes into account of both the hard and soft values of the data bits. With the reduction in the learning period, performance and power consumption are both improved.

FIG. 3 is a simplified block diagram of an embodiment of a reconfigurable processing system 50 having a plurality of context-based reconfigurable processors 52-53. The reconfigurable processing system 50 is a software-defined radio (SDR) that comprises N context-based reconfigurable processors 52-53, where N is at least two. The context-based reconfigurable processors 52-53 are interconnected and coupled to a memory 56, a digital signal processor (DSP) and/or direct memory access (DMA) module(s) 58, and a real-time sequencer 60 via an interconnect fabric 62. Each context-based reconfigurable processor may be a specialized processor operable to focus on a particular signal processing task. For example, one context-based reconfigurable processor may be a Viterbi processor that is optimized to perform Viterbi decoding operations. Another context-based reconfigurable processor may be a correlator processor that is optimized to perform correlation processes. Yet another context-based reconfigurable processor may be a turbo code decoder that is optimized to perform forward error correction decoding. One or more of these context-based reconfigurable processors may employ the decoder and method shown in FIG. 2 to reduce the overhead associated with trellis-based decoding processing.

Context-based reconfigurable processors 52-53 each include generic hardware modules that execute context-related instructions in an optimized manner. Each context-based reconfigurable processor may operate independently of one another under the scheduling and control of the real-time sequencer 60. One or more context-based reconfigurable processors may be independently inactivated or shut-down in applications that do not require them to optimize power consumption. The interconnect fabric 62 is reconfigurable and provides connectivity between the components in the reconfigurable processing system 50. Each context-based reconfigurable processor 52-53 may act as a master of the interconnect fabric 62 and may initiate access to the memory.

The reconfigurable processing system 50 may be used to implement a broadband modem of a mobile phone or similar wireless communications device. The device additionally comprises an RF (radio frequency) section 64 and a plurality of applications 66 to carry out specialized functions. Because the technology and standards for wireless communications is a continuously moving target, fixed hardware architecture for mobile phones becomes outdated very quickly. Therefore, a software-defined context-based reconfigurable system such as the system 50 can adapt to different technologies and standards now known and to be developed.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. A decoder comprising:
a demodulator operable to receive a plurality of encoded data bits and generate a demodulated output;
a channel decoder coupled to the demodulator operable to receive the demodulated output and generate decoded data bits;
an encoder coupled to the channel decoder operable to receive the decoded data bits and re-encode the decoded data bits and generate re-encoded data bits;
a comparator coupled to the demodulator and the encoder and operable to compare the demodulated output and the re-encoded data bits and generate an error rate; and
wherein the error rate from the comparator is used to modify an operating parameter of the channel decoder.

2. The decoder of claim 1, wherein the error rate from the comparator is used to modify a learning period length, L, of the channel decoder.

3. The decoder of claim 1, wherein the channel decoder receives the demodulated output as a soft-input.

4. The decoder of claim 1, wherein the comparator receives the demodulated output as a hard-input.

5. The decoder of claim 1, wherein the encoder receives the decoded data bits as a hard-input.

6. The decoder of claim 1, wherein the error rate comprises a bit-error-rate.

7. The decoder of claim 1, wherein the error rate comprises a frame-error-rate.

8. A method comprising:
receiving a plurality of encoded data bits and generating a demodulated output;
generating decoded data bits from the demodulated output;
receiving the decoded data bits, re-encoding the decoded data bits and generating re-encoded data bits;
comparing the demodulated output and re-encoded data bits and generating an error rate; and
modifying an operating parameter of the channel decoder in response to the error rate.

9. The method of claim 8, wherein modifying an operating parameter comprises modifying a learning period length, L, of the channel decoder.

10. The method of claim 8, wherein modifying an operating parameter comprises reducing a learning period length, L, of the channel decoder.

11. A wireless communication device comprising:
a radio frequency module receiving radio frequency and generate a plurality of encoded data bits;
a demodulator operable to receive the plurality of encoded data bits and generate a demodulated output;
a channel decoder coupled to the demodulator operable to receive the demodulated output and generate decoded data bits;
an encoder coupled to the channel decoder operable to receive the decoded data bits and re-encode the decoded data bits and generate re-encoded data bits;
a comparator coupled to the channel decoder and the encoder and operable to compare the demodulated output and re-encoded data bits and generate an error rate; and
wherein the error rate from the comparator is used to modify an operating parameter of the channel decoder.

12. The wireless communication device of claim 11, wherein the error rate from the comparator is used to modify a learning period length, L, of the channel decoder.

13. The wireless communication device of claim 11, wherein the error rate from the comparator is operable to reduce a learning period length, L, of the channel decoder.

14. The wireless communication device of claim 11, further comprising at least one context-based reconfigurable processor incorporating the demodulator, channel decoder, comparator, and encoder.

15. The wireless communication device of claim 11, further comprising:
a plurality of context-based reconfigurable processors incorporating the demodulator, channel decoder, comparator, and encoder; and
an interconnect fabric coupling the plurality of context-based reconfigurable processors.

16. The wireless communication device of claim 15, further comprising a sequencer controlling and scheduling the plurality of context-based reconfigurable processors.

17. A wireless device comprising:
a context-based reconfigurable processor comprising: a demodulator operable to receive a plurality of encoded data bits and generate a demodulated output;
a channel decoder coupled to the demodulator operable to receive the demodulated output and generate decoded data bits;
an encoder coupled to the channel decoder operable to receive the decoded data bits and re-encode the decoded data bits and generate re-encoded data bits;
a comparator coupled to the demodulator and the encoder and operable to compare the demodulated output and the re-encoded data bits and generate an error rate; and
wherein the error rate from the comparator reduces a learning period of the channel decoder.
